(19) United States
(12) Patent Application Publication
(10) Pub. No.: US 2026/0029087 A1
(43) Pub. Date: Jan. 29, 2026

(54) LADDER SAFETY DEVICE

(71) Applicant: Justin Abdoo, Gowen, MI (US)

(72) Inventor: Justin Abdoo, Gowen, MI (US)

(21) Appl. No.: 19/091,618

(22) Filed: Mar. 26, 2025

Related U.S. Application Data
(60) Provisional application No. 63/639,896, filed on Apr. 29, 2024.

(51) Int. Cl. F16M 13/02

(52) U.S. Cl. CPC F16M 13/02

(57) ABSTRACT

A ladder safety device includes a roof engagement structure adapted to be engaged with a roof. The roof engagement structure includes a flat body defining a plurality of engagement openings configured to receive fasteners for securing the roof engagement structure to the roof. The ladder safety device also includes a ladder retention structure including a plate body pivotally coupled to the flat body and a hook connected to the plate body. The hook is configured to engage a rung of a ladder. The ladder retention structure may include a lip extending outwardly from the hook and defining a first hole, with the plate body defining a second hole aligned with the first hole to enable insertion of a pin to secure the hook with the rung.

### CROSS-REFERENCE TO RELATED APPLICATIONS

This application claims priority to U.S. Application No. 63/639,896, titled LADDER SAFETY DEVICE, filed Apr. 29, 2024, which is hereby incorporated by reference in its entirety.

### FIELD OF INVENTION

The present disclosure relates to ladder safety devices, and more particularly to a ladder safety device for securing a ladder to a roof.

### BACKGROUND

Ladders are commonly used tools in various industries and household settings for accessing elevated areas. While ladders provide a practical solution for reaching heights, their use can present significant safety risks if not properly secured or stabilized. The potential for ladder accidents increases when working on uneven surfaces or in challenging environmental conditions.

Roof work, in particular, poses unique challenges for ladder safety. The slope of a roof and varying roofing materials can make it difficult to maintain a stable ladder position. Additionally, the transition between a ladder and a roof is a critical point where accidents frequently occur. Workers often struggle to maintain balance and secure footing when moving between the ladder and the roof surface.

Existing methods for securing ladders to roofs have limitations. Some approaches rely on makeshift solutions that may not provide adequate stability or may cause damage to the roofing material. Other methods involve complex installation procedures or specialized equipment that can be time-consuming to set up and remove. There is a need for a simple, effective, and versatile solution that can securely attach a ladder to various roof types while minimizing the risk of damage to the roof structure.

Improving ladder safety in roofing applications remains an ongoing challenge in the construction and maintenance industries. A reliable system for securing ladders to roofs could potentially reduce the number of accidents, increase worker confidence, and enhance overall productivity in tasks requiring roof access.

### SUMMARY

According to an aspect of the present disclosure, a ladder safety device is provided. The ladder safety device includes a roof engagement structure adapted to be engaged with a roof, the roof engagement structure including a flat body defining a plurality of engagement openings configured to receive fasteners for securing the roof engagement structure to the roof. The ladder safety device also includes a ladder retention structure including a plate body pivotally coupled to the flat body and a hook connected to the plate body, the hook configured to engage a rung of a ladder.

According to other aspects of the present disclosure, the ladder safety device may include one or more of the following features. The ladder retention structure may comprise a lip extending outwardly from the hook and defining a first hole, and the plate body may define a second hole disposed aligned with the first hole to enable insertion of a pin to secure the hook with the rung. The roof engagement structure may further comprise a hammer block arranged proximate to an edge of the flat body to enable hammering insertion of the flat body against the roof. The roof engagement structure may comprise at least one barrel arranged at an edge of the flat body, and the ladder retention structure may comprise at least one knuckle pivotally coupled to the at least one barrel. The ladder safety device may further comprise a first pin inserted through the at least one barrel and the at least one knuckle to pivotally couple the ladder retention structure to the roof engagement structure. The ladder safety device may further comprise a first lock pin engaged with the first pin to secure the first pin within the at least one barrel and the at least one knuckle. The hook may comprise a first plate, a second plate arranged spaced apart and substantially parallel to the first plate, and a connecting plate connecting the first plate to the second plate. The first plate may be arranged at a distance from the plate body, and the second plate may be connected to an end of the plate body and extends outwardly from the plate body. The plurality of engagement openings may include a plurality of angled slots and a plurality of nail holes arranged linearly between the plurality of angled slots and an edge of the flat body.

According to another aspect of the present disclosure, a method of securing a ladder to a roof is provided. The method includes engaging a roof engagement structure with a roof, the roof engagement structure including a flat body defining a plurality of engagement openings. The method also includes pivotally coupling a ladder retention structure to the roof engagement structure, and engaging a hook of the ladder retention structure with a rung of a ladder.

According to other aspects of the present disclosure, the method may include one or more of the following features. The method may further comprise inserting fasteners through the plurality of engagement openings to secure the roof engagement structure to the roof. The roof engagement structure may further comprise a hammer block, and the method may further comprise using the hammer block to drive the fasteners through the engagement openings. Pivotally coupling the ladder retention structure to the roof engagement structure may comprise inserting a pin through aligned barrels and knuckles on the roof engagement structure and ladder retention structure, respectively. The method may further comprise securing the pin with a lock pin to prevent disengagement of the ladder retention structure from the roof engagement structure. The method may further comprise inserting a securing pin through aligned holes in a lip of the hook and a plate body of the ladder retention structure to secure the hook to the ladder rung. The securing pin may be locked in place with a lock pin to prevent unintended disengagement of the hook from the ladder rung.

According to another aspect of the present disclosure, a ladder safety system is provided. The ladder safety system includes a roof engagement structure including a flat body with a plurality of engagement openings for securing to a roof, a ladder retention structure pivotally coupled to the roof engagement structure, and a locking mechanism for securing the ladder retention structure to a ladder rung.

According to other aspects of the present disclosure, the ladder safety system may include one or more of the following features. The ladder retention structure may comprise a plate body and a hook connected to the plate body, the hook configured to engage the ladder rung. The locking mechanism may comprise a lip extending outwardly from the hook and defining a first hole, and the plate body may define a second hole aligned with the first hole to enable insertion of a securing pin. The ladder safety system may further comprise a lock pin configured to engage with the securing pin to prevent unintended disengagement of the hook from the ladder rung.

The foregoing general description of the illustrative embodiments and the following detailed description thereof are merely exemplary aspects of the teachings of this disclosure and are not restrictive.

For a more complete understanding, reference is made to the following detailed description and accompanying drawings. In the drawings, like reference characters refer to like parts throughout the views in which:

### BRIEF DESCRIPTION OF FIGURES

FIG. 1 illustrates a front perspective view of a ladder safety device securing a ladder to a roof, in accordance with an embodiment of the disclosure;

FIG. 2 illustrates a top perspective view of the ladder safety device, in accordance with an embodiment of the disclosure; and

FIG. 3 illustrates an exploded view of the ladder safety device, in accordance with an embodiment of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a ladder safety device designed to enhance the stability and security of ladders when used on roofs. The ladder safety device comprises two main components: a roof engagement structure and a ladder retention structure.

The roof engagement structure is adapted to be engaged with a roof, providing a secure anchor point for the device. This structure is designed to accommodate various roof types and pitches, ensuring versatility across different applications.

The ladder retention structure includes a plate body that is pivotally coupled to the roof engagement structure. This pivotal coupling allows for adjustability, enabling the device to adapt to different roof angles and ladder positions.

Connected to the plate body of the ladder retention structure is a hook. This hook is configured to engage a rung of a ladder, providing a secure attachment point between the ladder and the roof engagement structure. The hook design may accommodate various ladder rung shapes and sizes, enhancing the device's compatibility with different ladder types.

By combining these components, the ladder safety device aims to provide a robust and adaptable solution for securing ladders to roofs, potentially improving safety and stability during roof-related tasks.

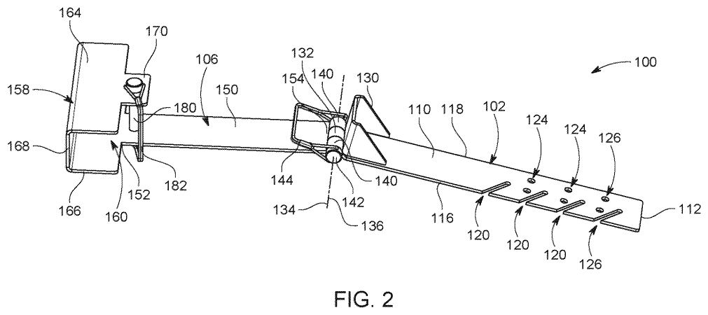

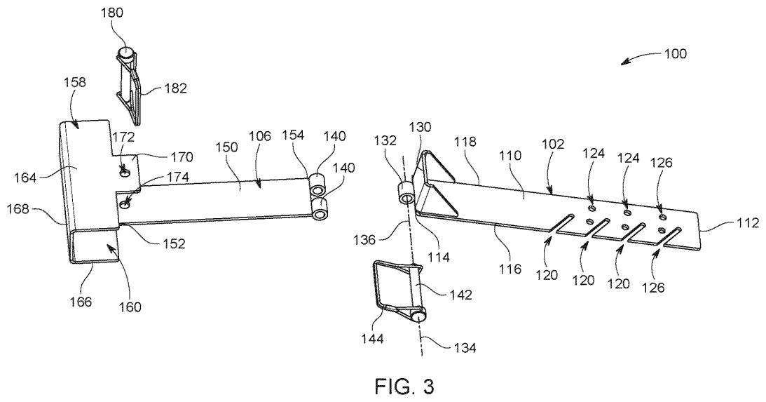

Referring to FIG. 2 and FIG. 3, a roof engagement structure 102 of the ladder safety device 100 may be seen. The roof engagement structure 102 includes a flat body 110 defining a plurality of engagement openings 126 configured to receive fasteners for securing the roof engagement structure 102 to a roof. The flat body 110 may have a first lateral edge 112, a second lateral edge 114, a first longitudinal edge 116, and a second longitudinal edge 118.

In some cases, the plurality of engagement openings 126 may include a plurality of engagement slots 120 and a plurality of nail holes 124. The engagement slots 120 may extend at an inclination from the first longitudinal edge 116 towards the second longitudinal edge 118. In some implementations, the engagement slots 120 may extend obliquely and upwardly towards the first lateral edge 112 from the first longitudinal edge 116. The nail holes 124 may be arranged linearly between the plurality of engagement slots 120 and the second longitudinal edge 118 in the lateral direction.

The roof engagement structure 102 may further comprise a hammer block 130 arranged proximate to the second lateral edge 114 of the flat body 110. The hammer block 130 may enable hammering insertion of the flat body 110 against the roof. In some cases, at least one barrel 132 may be arranged at the second lateral edge 114 of the flat body 110.

The roof engagement structure 102 may be fabricated from various materials to suit different applications and environmental conditions. In some implementations, the roof engagement structure 102 may be made from metal, such as steel, aluminum, stainless steel, or any other suitable type of metal that may be corrosion resistant. Alternatively, the roof engagement structure 102 may be constructed from plastic or composite materials. In such cases, the chosen material may be high strength and have resistance to weathering, wear, or fatigue from cold or sun's UV rays.

The configuration of the roof engagement structure 102 may allow for secure attachment to various roof types and pitches. The angled arrangement of the engagement slots 120 may provide flexibility in positioning and securing the flat body 110 to the roof. The nail holes 124 may offer additional attachment points for enhanced stability. The hammer block 130 may facilitate the installation process by providing a designated impact point for driving the flat body 110 into position on the roof. In some cases, the hammer block 130 may additionally be used as a striking point by a hammer to drive the roof engagement structure 102 upward along the slope of the roof to release it from any nails in the engagement slots 120. This feature may allow for easier removal or repositioning of the device when needed.

Based upon the foregoing disclosure, it is seen that the present disclosure provides a roof engagement structure that may offer versatility in securing a ladder safety device to different roof configurations. The angled slots and multiple attachment points may surpass prior art solutions by allowing for adaptable and secure mounting on various roof pitches and materials. The inclusion of a hammer block may enhance ease of installation, potentially improving safety and efficiency during setup compared to conventional ladder securing methods.

Referring to FIG. 2 and FIG. 3, a ladder retention structure 106 of the ladder safety device 100 may be seen. The ladder retention structure 106 may include a plate body 150 having a first end 152 and a second end 154. In some cases, the plate body 150 may be pivotally coupled to the flat body 110 of the roof engagement structure 102.

The ladder retention structure 106 may further include a retention hook 158 connected to the first end 152 of the plate body 150. The retention hook 158 may be configured to engage a rung of a ladder. In some implementations, the retention hook 158 may include a hook opening 160 arranged facing or oriented towards the roof engagement structure 102.

The retention hook 158 may comprise a first plate 164, a second plate 166 arranged spaced apart and substantially parallel to the first plate 164, and a connecting plate 168 connecting the first plate 164 to the second plate 166. This configuration may result in a substantially horizontally oriented U-shape or C-shape for the retention hook 158. In some cases, the first plate 164 may be arranged at a distance, such as a vertical distance, from the plate body 150. The second plate 166 may be connected to the first end 152 of the plate body 150 and may extend outwardly of the first end 152 of the plate body 150 in a direction opposite to the extension of the roof engagement structure 102 from the plate body 150.

The ladder retention structure 106 may also include a retention lip 170 extending outwardly from the retention hook 158. In some implementations, the retention lip 170 may extend towards the second end 154 of the plate body 150 from a free end of the second plate 166. The retention lip 170 may be disposed substantially parallel to and spaced apart from the plate body 150, and may overlap a portion of the plate body 150 disposed adjacent to the retention hook 158.

In some cases, the retention lip 170 may define a first hole 172, and the plate body 150 may define a second hole 174 disposed aligned with the first hole 172. This alignment may enable insertion of a pin to secure the retention hook 158 with the ladder rung.

The configuration of the retention hook 158 may allow for versatility in engagement with ladder rungs. In some implementations, the retention hook 158 may be vertically rotated such that the first plate 164 is oriented below the second plate 166. Alternatively, the retention hook 158 may be similar to a traditional hook or plurality of hooks having a continuously curved inner surface, such as the shape of a hook on a fishing lure.

The ladder retention structure may incorporate various hook designs to accommodate different ladder types and provide secure attachment. In some implementations, the retention hook may take the form of an S-shaped hook, which may allow for engagement with ladder rungs from multiple angles. The S-shape may provide two curved sections, potentially enabling the hook to wrap around a rung and offer additional stability.

J-hooks may be utilized in some aspects of the ladder retention structure. These hooks may feature a longer straight section with a curved end, which may allow for easy placement over ladder rungs. The J-hook design may provide a deep pocket for the rung to sit in, potentially increasing the security of the attachment.

In certain implementations, the retention mechanism may employ C-clamps or claw hooks. These designs may utilize a clamping action to grip the ladder rung firmly. The clamping mechanism may be adjustable in some cases, allowing for adaptation to various rung sizes and shapes.

Spring-loaded hooks may be incorporated into some versions of the ladder retention structure. These hooks may feature a spring mechanism that automatically adjusts to grip the ladder rung when engaged. The spring action may provide constant tension, potentially enhancing the security of the attachment and accommodating slight variations in rung dimensions.

Rotating or swiveling hooks may be utilized in some implementations of the ladder retention structure. These hooks may be designed to pivot or rotate around an axis, potentially allowing for greater flexibility in positioning the ladder against the roof. The ability to swivel may enable the hook to align with the ladder rung regardless of the angle at which the ladder is placed.

Ball and socket hooks may be employed in certain aspects of the ladder retention structure. This design may feature a ball joint that allows for multi-directional movement of the hook. The ball and socket configuration may provide enhanced adaptability to various ladder angles and roof pitches.

In some implementations, the retention hook may incorporate a locking or pin-hinged mechanism. These hooks may feature a hinged section that can be opened to receive the ladder rung and then closed and secured with a locking pin. This design may provide an additional layer of security by preventing unintended disengagement of the hook from the ladder rung.

Each of these hook designs may offer unique advantages and may be selected based on specific application requirements, ladder types, or user preferences. The variety of hook options may enhance the versatility and adaptability of the ladder safety device across different scenarios and environments.

Based upon the foregoing disclosure, it is seen that the present disclosure provides a ladder retention structure that may offer secure and adaptable engagement with various ladder types. The retention hook design, with its adjustable orientation and secure locking mechanism, may surpass prior art solutions by accommodating different ladder rung configurations while maintaining a stable connection. The inclusion of the retention lip with aligned holes for pin insertion may enhance the security of the ladder attachment, potentially improving safety compared to conventional ladder securing methods.

Referring to FIG. 2 and FIG. 3, the ladder safety device 100 may include a pivotal coupling mechanism between the roof engagement structure 102 and the ladder retention structure 106. This mechanism may allow for adjustable positioning of the ladder retention structure 106 relative to the roof engagement structure 102, potentially accommodating various roof pitches and ladder angles.

The roof engagement structure 102 may comprise at least one barrel 132 arranged at the second lateral edge 114 of the flat body 110. In some cases, the at least one barrel 132 may define a pivot axis 134 that coincides with a central axis 136 of the at least one barrel 132.

The ladder retention structure 106 may comprise at least one knuckle 140 configured to align with the at least one barrel 132. In some implementations, the at least one knuckle 140 may be positioned at the second end 154 of the plate body 150.

In some implementations, the pivotal coupling mechanism between the roof engagement structure and the ladder retention structure may utilize alternative hinge designs to achieve the desired rotational movement. For example, a continuous hinge, also known as a piano hinge, may be employed to provide a smooth and distributed pivoting action along the entire length of the connection point. This type of hinge may include a series of interlocking knuckles or loops that extend along the edges of both the roof engagement structure and the ladder retention structure, with a pin running through the entire length to form the pivot axis.

In other aspects, the pivotal connection may be achieved through the use of a ball hinge. This configuration may allow for a wider range of motion, potentially enabling the ladder retention structure to pivot in multiple directions relative to the roof engagement structure. The ball component may be integrated into one structure, while the corresponding socket may be formed in the other, creating a secure yet flexible connection point.

Some embodiments may incorporate a barrel nut hinge design, where a cylindrical barrel element, typically hollow, has a pin or shaft passing through it to secure the roof engagement structure and the ladder retention structure. The pin is inserted into the barrel and can rotate or pivot within it, allowing for movement of the connected components.

In yet other implementations, the pivotal coupling may be accomplished through the use of a concealed hinge mechanism. This design may be fully or partially hidden when the connected components are closed, providing aesthetic appeal while maintaining rotational movement between the roof engagement structure and the ladder retention structure.

Some variations of the ladder safety device may employ a knuckle hinge system, where two interlocking, cylindrical portions (knuckles) and a pin passing through these knuckles allow the components to rotate about the hinge axis. This facilitates angular motion between the roof engagement structure and the ladder retention structure while providing structural stability.

In certain cases, the pivotal coupling may be achieved through a pivot hinge arrangement, where the rotating axis is offset from the centerline of the components. This type of hinge allows one or both components to pivot around a point that is not directly aligned with the axis of rotation, providing additional flexibility in positioning the ladder against the roof.

The ladder safety device may, in some implementations, utilize a spring hinge, wherein a spring mechanism is incorporated into the hinge design. The spring provides resistance and assists in closing or maintaining a set position of the hinged components, which may help stabilize the ladder retention structure at a desired angle relative to the roof engagement structure.

In other aspects, the pivotal connection may be accomplished through the use of an offset hinge. This mechanism is designed to mount one of the components further away from the pivot axis, often used to create additional clearance for components when they rotate, providing a specific angular range or space advantage between the roof engagement structure and the ladder retention structure.

Some embodiments of the ladder safety device may incorporate a swivel hinge mechanism, characterized by the ability to rotate around a central pivot point, facilitating angular motion between the roof engagement structure and the ladder retention structure. This type of hinge may include a rotating ball, socket, or pin arrangement, which enables the components to rotate in multiple directions relative to one another.

Turning back to the embodiment shown in FIGS. 2 and 3, to pivotally couple the ladder retention structure 106 to the roof engagement structure 102, a first pin 142 may be inserted through the aligned at least one barrel 132 and the at least one knuckle 140. This arrangement may allow the ladder retention structure 106 to rotate about the pivot axis 134 relative to the roof engagement structure 102.

In some cases, to secure the first pin 142 within the at least one barrel 132 and the at least one knuckle 140, a first lock pin 144 may be engaged with the first pin 142. The first lock pin 144 may prevent unintended disengagement of the first pin 142, thereby maintaining the pivotal connection between the roof engagement structure 102 and the ladder retention structure 106.

The pivotal coupling mechanism may allow the ladder retention structure 106 to be adjusted to various angles relative to the roof engagement structure 102. This adjustability may enable the ladder safety device 100 to accommodate different roof pitches and ladder positions while maintaining a secure connection between the roof and the ladder.

In some implementations, the pivotal coupling mechanism may allow for a range of motion that includes the ability to extend the ladder retention structure 106 straight outwardly from the roof engagement structure 102 or straight downwardly. This extensive range of motion may provide flexibility in positioning the ladder safety device 100 on various roof configurations.

Based upon the foregoing disclosure, it is seen that the present disclosure provides a pivotal coupling mechanism that may offer enhanced adaptability compared to prior art ladder securing devices. The ability to adjust the angle between the roof engagement structure and the ladder retention structure may surpass conventional fixed-angle designs by accommodating a wider range of roof pitches and ladder positions. The inclusion of a locking mechanism for the pivotal connection may enhance the stability and security of the ladder attachment, potentially improving safety in diverse roofing scenarios.

Referring to FIG. 2 and FIG. 3, the ladder safety device 100 may include a securing mechanism for locking a ladder rung in place. This securing mechanism may comprise a second pin 180 and a second lock pin 182, which work in conjunction with the retention hook 158 and the plate body 150 of the ladder retention structure 106.

In some cases, the retention lip 170 of the retention hook 158 may define the first hole 172, while the plate body 150 may define the second hole 174. The first hole 172 and the second hole 174 may be aligned to enable insertion of the second pin 180. This alignment may allow the second pin 180 to pass through both the retention lip 170 and the plate body 150, effectively securing a ladder rung within the retention hook 158. However, it should be noted that the use of the second pin 180 is optional and not required for the basic functionality of the ladder safety device.

The second pin 180 may be inserted through the aligned first hole 172 and second hole 174 after the retention hook 158 has engaged with a ladder rung. In some implementations, the second pin 180 may prevent removal of the ladder rung from the retention hook 158 through the hook opening 160. While the second pin 180 may provide additional security, the retention hook 158 may be capable of engaging and securing a ladder rung without the use of the second pin 180 in certain situations or configurations.

To further secure the second pin 180 in position and prevent any undesired removal, the second lock pin 182 may be engaged with the second pin 180. The second lock pin 182 may act as a locking mechanism, ensuring that the second pin 180 remains in place within the first hole 172 and the second hole 174.

In some cases, the securing mechanism may function as follows:
1. The retention hook 158 may be engaged with a ladder rung, with the rung positioned within the hook opening 160.
2. The second pin 180 may be inserted through the aligned first hole 172 in the retention lip 170 and the second hole 174 in the plate body 150.
3. The second lock pin 182 may be engaged with the second pin 180, locking the second pin 180 in position.

This configuration may create a secure connection between the ladder retention structure 106 and the ladder rung, preventing unintended disengagement during use.

The securing mechanism may be designed to accommodate various ladder rung sizes and shapes. In some implementations, the distance between the retention lip 170 and the plate body 150 may be sufficient to allow for different rung diameters while still providing a secure fit when the second pin 180 is inserted.

Based upon the foregoing disclosure, it is seen that the present disclosure provides a securing mechanism that may offer enhanced safety and stability compared to prior art ladder securing devices. The use of the second pin 180 in conjunction with the aligned holes in the retention lip 170 and plate body 150 may surpass conventional hook designs by providing a positive locking mechanism. The addition of the second lock pin 182 may further enhance the security of the ladder attachment, potentially reducing the risk of accidental disengagement in diverse roofing scenarios.

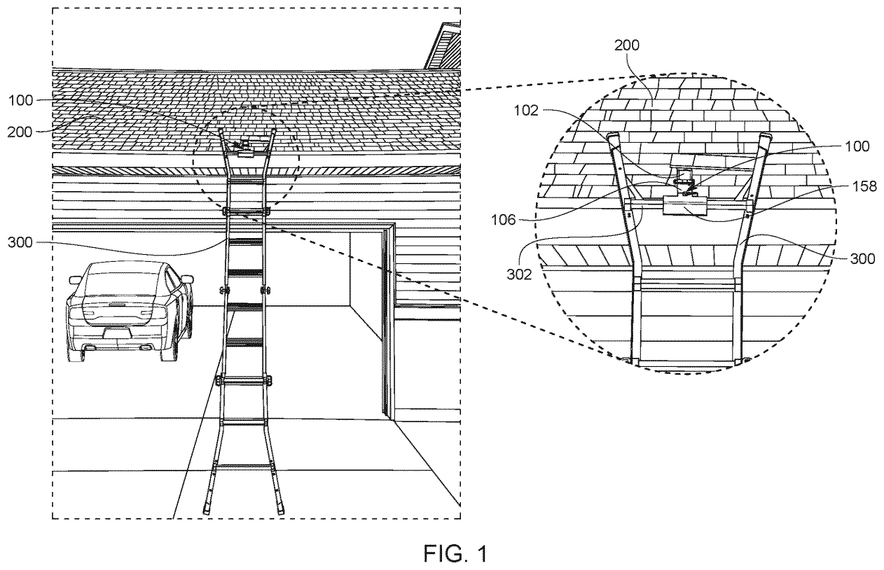

Referring to FIG. 1, the ladder safety device 100 may be seen securing a ladder 300 to a roof 200. The ladder safety device 100 may comprise the roof engagement structure 102 and the ladder retention structure 106, which work together to provide a secure connection between the ladder 300 and the roof 200.

In some cases, the method of securing the ladder 300 to the roof 200 may involve engaging the roof engagement structure 102 with the roof 200. The flat body 110 of the roof engagement structure 102 may be positioned on the roof 200, with the engagement slots 120 and nail holes 124 aligned for fastener insertion. Fasteners may be inserted through the engagement openings 126 to secure the roof engagement structure 102 to the roof 200. The hammer block 130 may be used to drive the fasteners through the engagement openings 126, facilitating a secure attachment to the roof 200. Additionally, the hammer block 130 may be used as a striking point by a hammer to drive the roof engagement structure 102 upward along the slope of the roof to release it from any nails in the engagement slots 120. This feature may allow for easier removal or repositioning of the device when needed.

The ladder retention structure 106 may be pivotally coupled to the roof engagement structure 102. In some implementations, this pivotal coupling may involve inserting the first pin 142 through the aligned barrels 132 on the roof engagement structure 102 and the knuckles 140 on the ladder retention structure 106. The first lock pin 144 may be used to secure the first pin 142, preventing disengagement of the ladder retention structure 106 from the roof engagement structure 102.

The method may further involve engaging the retention hook 158 of the ladder retention structure 106 with a ladder rung 302 of the ladder 300. The retention hook 158 may be positioned around the ladder rung 302, with the ladder rung 302 seated within the hook opening 160.

To secure the retention hook 158 to the ladder rung 302, the second pin 180 may be inserted through the aligned first hole 172 in the retention lip 170 and the second hole 174 in the plate body 150. The second lock pin 182 may then be engaged with the second pin 180, locking the second pin 180 in place. This configuration may prevent unintended disengagement of the retention hook 158 from the ladder rung 302.

The pivotal coupling between the roof engagement structure 102 and the ladder retention structure 106 may allow for adjustment of the ladder 300 angle relative to the roof 200. This adjustability may enable the ladder safety device 100 to accommodate various roof pitches while maintaining a secure connection between the ladder 300 and the roof 200.

Based upon the foregoing disclosure, it is seen that the present disclosure provides a ladder safety device that may offer enhanced stability and security compared to prior art ladder securing methods. The combination of the roof engagement structure and the pivotally coupled ladder retention structure may surpass conventional ladder securing devices by providing adaptability to various roof pitches and ladder positions. The multiple locking mechanisms, including the fasteners for roof attachment and the pins for securing the ladder rung, may enhance the overall safety and reliability of the ladder setup in diverse roofing scenarios.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A ladder safety device, comprising:
a roof engagement structure adapted to be engaged with a roof, the roof engagement structure including a flat body defining a plurality of engagement openings configured to receive fasteners for securing the roof engagement structure to the roof; and
a ladder retention structure including a plate body pivotally coupled to the flat body and a hook connected to the plate body, the hook configured to engage a rung of a ladder.

2. The ladder safety device of claim 1, wherein the ladder retention structure comprises a lip extending outwardly from the hook and defining a first hole, and the plate body defines a second hole disposed aligned with the first hole to enable insertion of a pin to secure the hook with the rung.

3. The ladder safety device of claim 1, wherein the roof engagement structure further comprises a hammer block arranged proximate to an edge of the flat body to enable hammering insertion of the flat body against the roof.

4. The ladder safety device of claim 1, wherein the roof engagement structure comprises at least one barrel arranged at an edge of the flat body, and the ladder retention structure comprises at least one knuckle pivotally coupled to the at least one barrel.

5. The ladder safety device of claim 4, further comprising a first pin inserted through the at least one barrel and the at least one knuckle to pivotally couple the ladder retention structure to the roof engagement structure.

6. The ladder safety device of claim 5, further comprising a first lock pin engaged with the first pin to secure the first pin within the at least one barrel and the at least one knuckle.

7. The ladder safety device of claim 1, wherein the hook comprises a first plate, a second plate arranged spaced apart and substantially parallel to the first plate, and a connecting plate connecting the first plate to the second plate.

8. The ladder safety device of claim 7, wherein the first plate is arranged at a distance from the plate body, and the second plate is connected to an end of the plate body and extends outwardly from the plate body.

9. The ladder safety device of claim 1, wherein the plurality of engagement openings includes a plurality of angled slots and a plurality of nail holes arranged linearly between the plurality of angled slots and an edge of the flat body.

10. A method of securing a ladder to a roof, comprising:
engaging a roof engagement structure with a roof, the roof engagement structure including a flat body defining a plurality of engagement openings;
pivotally coupling a ladder retention structure to the roof engagement structure; and
engaging a hook of the ladder retention structure with a rung of a ladder.

11. The method of claim 10, further comprising inserting fasteners through the plurality of engagement openings to secure the roof engagement structure to the roof.

12. The method of claim 11, wherein the roof engagement structure further comprises a hammer block, and the method further comprises using the hammer block to drive the fasteners through the engagement openings.

13. The method of claim 10, wherein pivotally coupling the ladder retention structure to the roof engagement structure comprises inserting a pin through aligned barrels and knuckles on the roof engagement structure and ladder retention structure, respectively.

14. The method of claim 13, further comprising securing the pin with a lock pin to prevent disengagement of the ladder retention structure from the roof engagement structure.

15. The method of claim 10, further comprising inserting a securing pin through aligned holes in a lip of the hook and a plate body of the ladder retention structure to secure the hook to the ladder rung.

16. The method of claim 15, wherein the securing pin is locked in place with a lock pin to prevent unintended disengagement of the hook from the ladder rung.

17. A ladder safety system, comprising:
a roof engagement structure including a flat body with a plurality of engagement openings for securing to a roof;
a ladder retention structure pivotally coupled to the roof engagement structure; and
a locking mechanism for securing the ladder retention structure to a ladder rung.

18. The ladder safety system of claim 17, wherein the ladder retention structure comprises a plate body and a hook connected to the plate body, the hook configured to engage the ladder rung.

19. The ladder safety system of claim 18, wherein the locking mechanism comprises a lip extending outwardly from the hook and defining a first hole, and the plate body defines a second hole aligned with the first hole to enable insertion of a securing pin.

20. The ladder safety system of claim 19, further comprising a lock pin configured to engage with the securing pin to prevent unintended disengagement of the hook from the ladder rung.
